(19) United States
(12) Patent Application Publication
(10) Pub. No.: US 2012/0233554 A1
(43) Pub. Date: Sep. 13, 2012

(54) Collaborative Electronic Document Editing

(75) Inventors: Vance J. Vagell, Jamaica, NY (US); Antonella Pavese, Brooklyn, NY (US)

(73) Assignee: GOOGLE, INC., Mountain View, CA (US)

(21) Appl. No.: 13/271,539

(22) Filed: Oct. 12, 2011

Related U.S. Application Data
(63) Continuation of application No. 13/042,772, filed on Mar. 8, 2011.

(51) Int. Cl. G06F 3/01

(52) U.S. Cl. 715/751

(57) ABSTRACT

A collaborative editing environment is configured to display a modification to a document made by a user in a first user-style. The style of the modification is gradually transformed from the first user-style to a document-style, such that the style in which the modification is displayed provides an indication as to authorship and recency of the modification. The transformation can occur gradually over a first configurable time period. A second modification to a document made by a second user is displayed in a style associated with the second user. The display of the second modification is also transformed from the second user-style to the document style. The transformation of the display of the first modification and the transformation of the display of the second modification can be performed concurrently, and the duration of the first transformation can be different from the duration of the second transformation.

### TECHNICAL FIELD

The present disclosure is generally directed to electronic document editing, and more particularly to conveying information concerning modifications made to an electronic document in a collaborative editing environment.

### BACKGROUND

Electronic documents are frequently viewed and edited by multiple users. Certain reviewing tools track modifications to a document by presenting additions to the document in a first style (e.g., added text is as underlined) and present deletions from the document in a second style (e.g., deleted text is displayed in strikethrough). Reviewing tools can also present modifications made by different users in a different colors, thereby allowing a reviewer to associate a particular modification to a particular user based on the color of the modification.

Review of another user's modifications is performed non-contemporaneously with the entry of the modifications. That is, in order to review another user's modifications, the reviewing user must wait until the modifying user enters all the desired modifications, saves the working document, and closes the document. The reviewing user can then open the document and individually review each modification. Thus, most reviewing tools are incompatible with collaborative editing environments that allow multiple users to simultaneously revise a document.

### SUMMARY

In accordance with an embodiment, a collaborative editing environment displays modifications to a document in a style associated with the user modifying the document. The style of the modifications is then transformed from the style associated with the user to a style associated with the underlying document. The transformation may occur over a first time period.

In accordance with an embodiment, modifications to the document by a second user are displayed in a style associated with the second user. The display of the modifications by the second user is then transformed from the style associated with the second user to the style of the document style. The transformation of the display of the first and second user modifications can be performed concurrently. The time period of transformation of the first user modifications can be different from the time period of transformation of the second user modification.

In accordance with an embodiment, a collaborative editing environment includes means for displaying modifications to a document in a style associated with the user modifying the document. The collaborative editing environment further includes means for transforming the style of the modifications from the style associated with the user to a style associated with the underlying document. The transformation may occur over a first time period.

These and other advantages will be apparent to those of ordinary skill in the art by reference to the following detailed description and the accompanying drawings.

### BRIEF DESCRIPTION OF THE DRAWINGS

FIG. 1 is a diagram of an exemplary environment in which the present disclosure may be implemented;

FIGS. 2A-2G are exemplary displays of a collaborative editing environment, each at a specific instant during a collaborative editing session;

FIG. 3 is an exemplary flow diagram of a process in accordance with an embodiment of the present disclosure; and

FIG. 4 is a high-level diagram of a computer that may be used to implement various aspects of the present disclosure in certain embodiments.

### DETAILED DESCRIPTION

In accordance with an embodiment of the present disclosure, multiple users can concurrently, and in real-time, view and modify a document in a collaborative editing environment that displays each user's modification in a style associated with the user. As time passes, the display of each modification is transformed from the user-associated style to a style of the document being edited. Thus, based on the style of the modification and the progress of the transformation to the style of the underlying document, a user can determine the authorship of the modification and the recency of the modification.

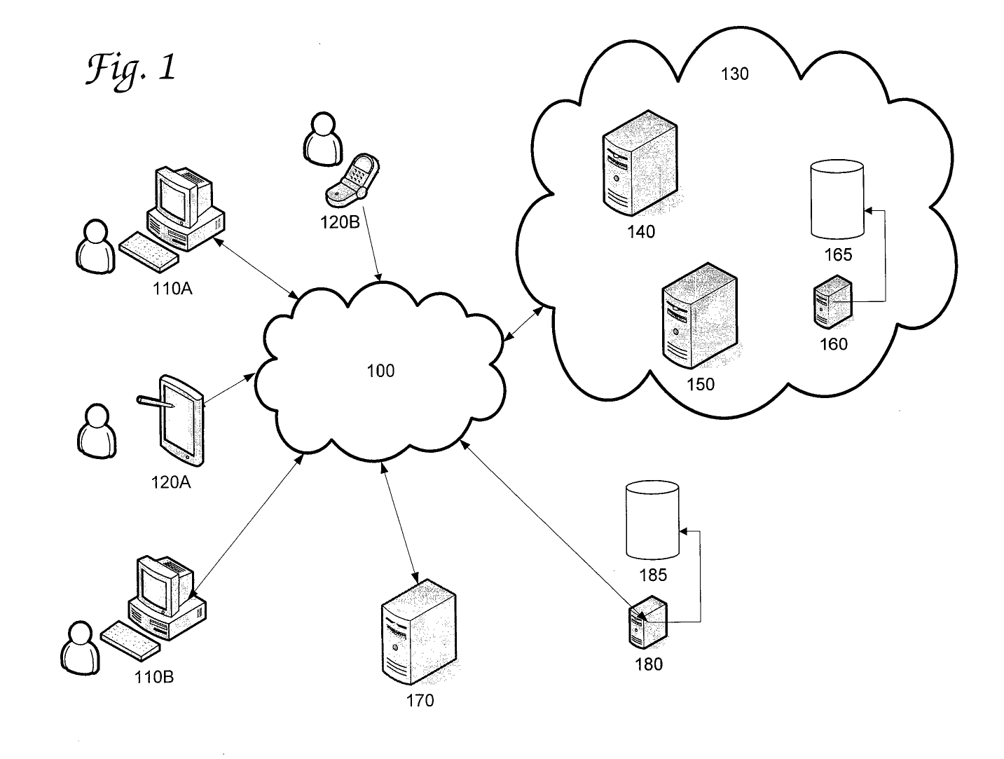

The collaborative editing environment can be provided and accessed in a variety of forms. FIG. 1 illustrates an exemplary network 100 in which the collaborative editing environment may be implemented.

In one exemplary embodiment, the collaborative editing environment can be provided by a cloud-computing environment 130. As illustrated, users at computer 110A and computer 110B could access the collaborative environment provide by cloud 130 via network 100. Users of portable devices, such as tablet computer 120A, cellular telephone 120B, or other mobile computing devices, can also access the collaborative environment. Within the cloud 130, servers 140, 150, and/or 160 can provided the services of the collaborative editing environment. For example, server 140 may provide a web-enabled application implementing the collaborative editing environment. Documents edited within the web-enabled application can be stored in database 165 accessed via a database server 160, and access to the web-enabled application can be provided via a webpage at server 150. Various functions and aspects of the collaborative editing environment can be provided by various combinations of servers and computers. A web-based implementation of the collaborative editing environment can be created using standard technologies such as HTML, XML, JavaScript, CSS, CSS3, and PHP.

In a further embodiment, a specific server (e.g. server 170 or server 180) can host a network application providing the collaborative editing environment that is accessible by computers 110A and 110B, tablet computer 120A, and cellular telephone 120B. In accordance with this embodiment, the network application can be accessed via the Internet or as a standalone network application (e.g., an application provided within a company intranet). In an intranet environment, a server 170 hosting the network-based collaborative editing application can access documents from a document management server 180, which is connected to a database 185.

The network-based collaborative editing application can alternatively be hosted by user computer (e.g., computer 110B acting as a server). In such a configuration, other computers, such as computer 110A could connect to computer 110B to access the collaborative editing environment.

In yet a further embodiment, the collaborative editing environment can be provided as a peer-to-peer application. That is, for example, computers 110A and 110B, tablet computer 120A, and cellular telephone 120B can execute a common application that can connect to each other computer executing the same application via network 100. In this configuration, the document being edited can be stored at computers 110A and 110B, tablet computer 120A, and cellular telephone 120B, accessed via cloud 130, or retrieved from a file server 180 and database 185. Modifications that are made at one of the computers (e.g., computer 110A) and other application data are then distributed to its peers (e.g., computer 110B, tablet computer 120A, and cellular telephone 120B), which can include any computer accessing a common document or only those computers connected in a collaborative editing session.

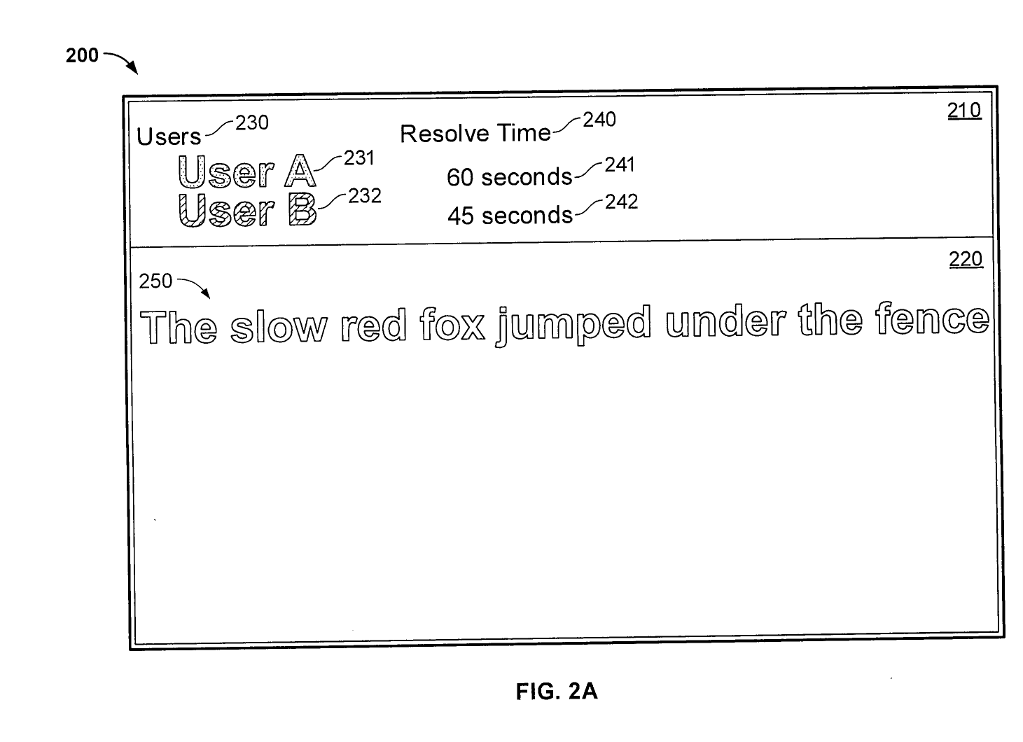

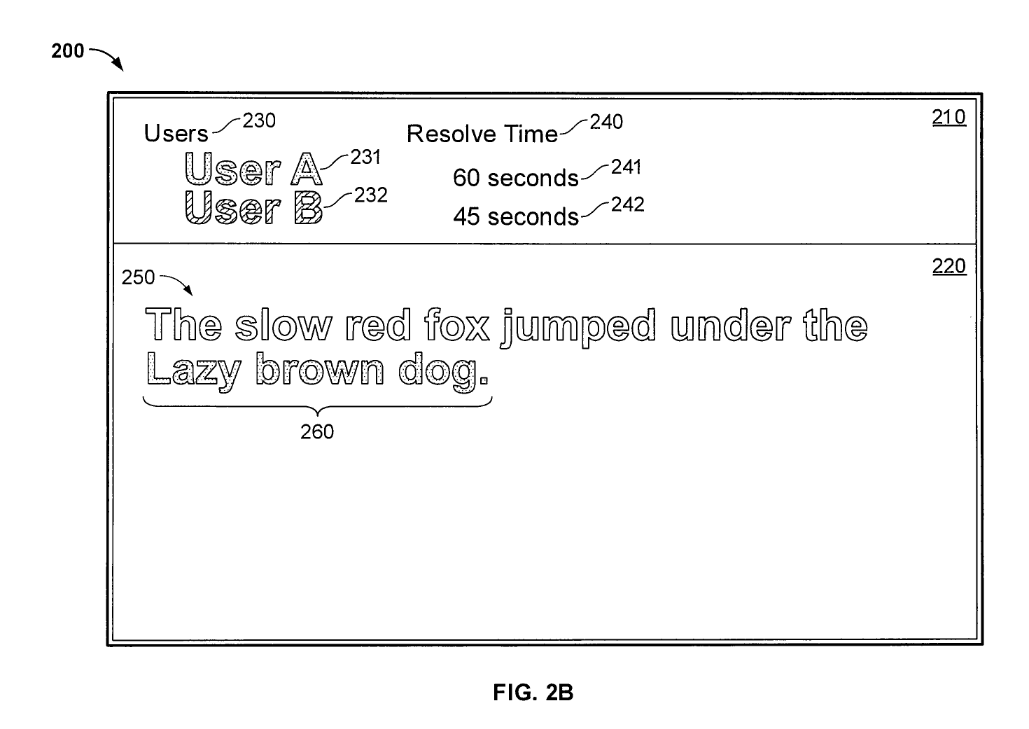

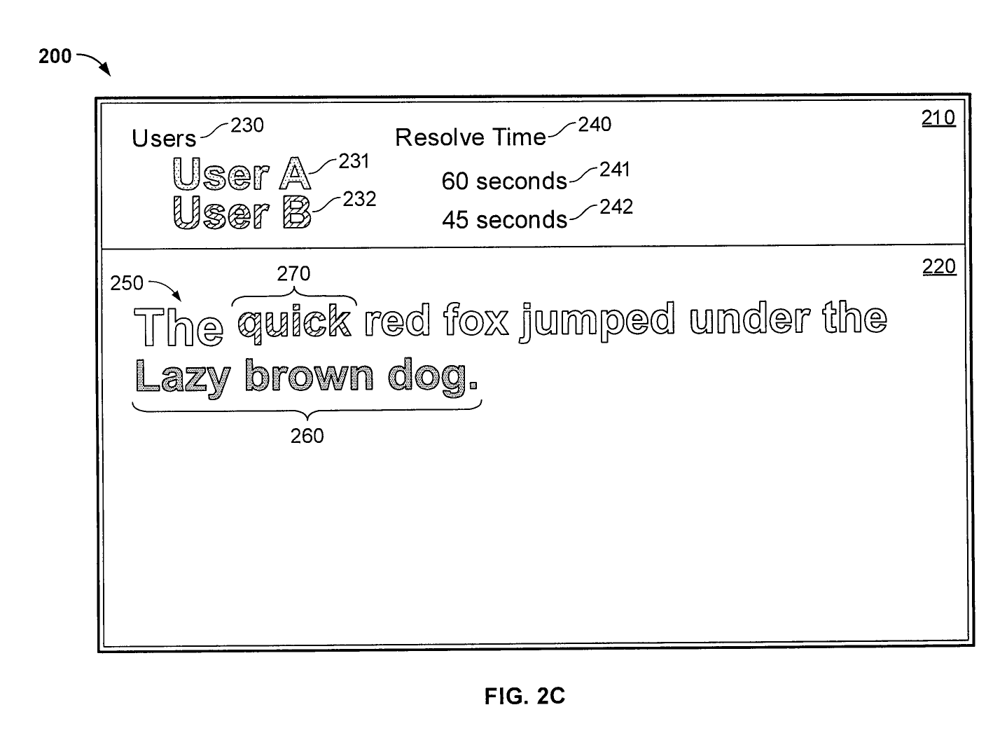

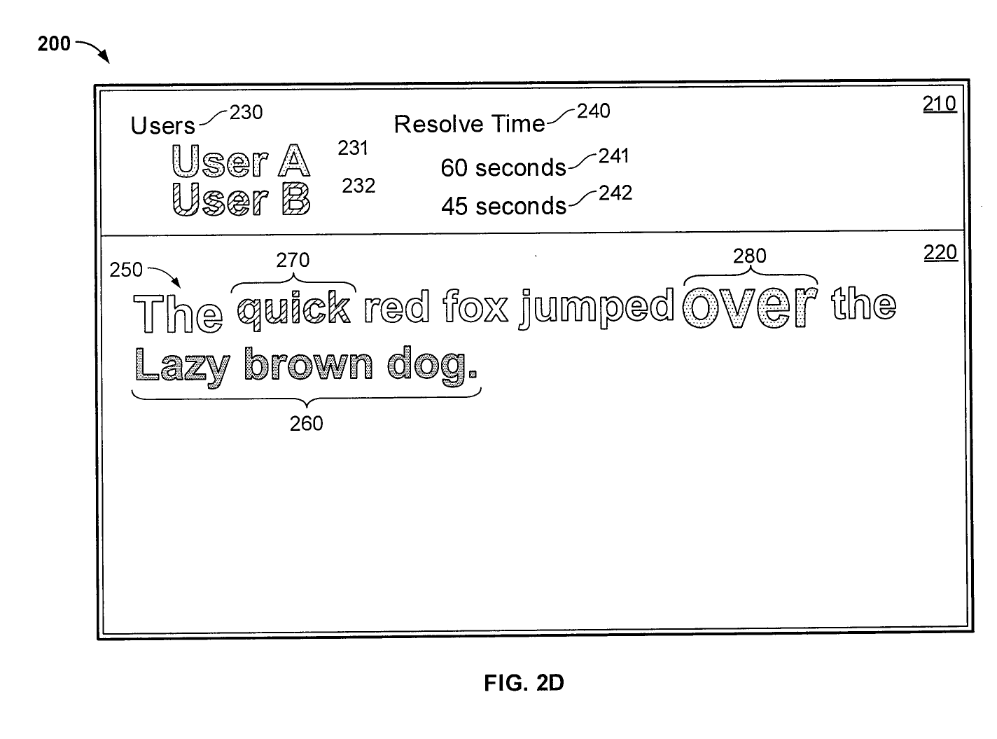

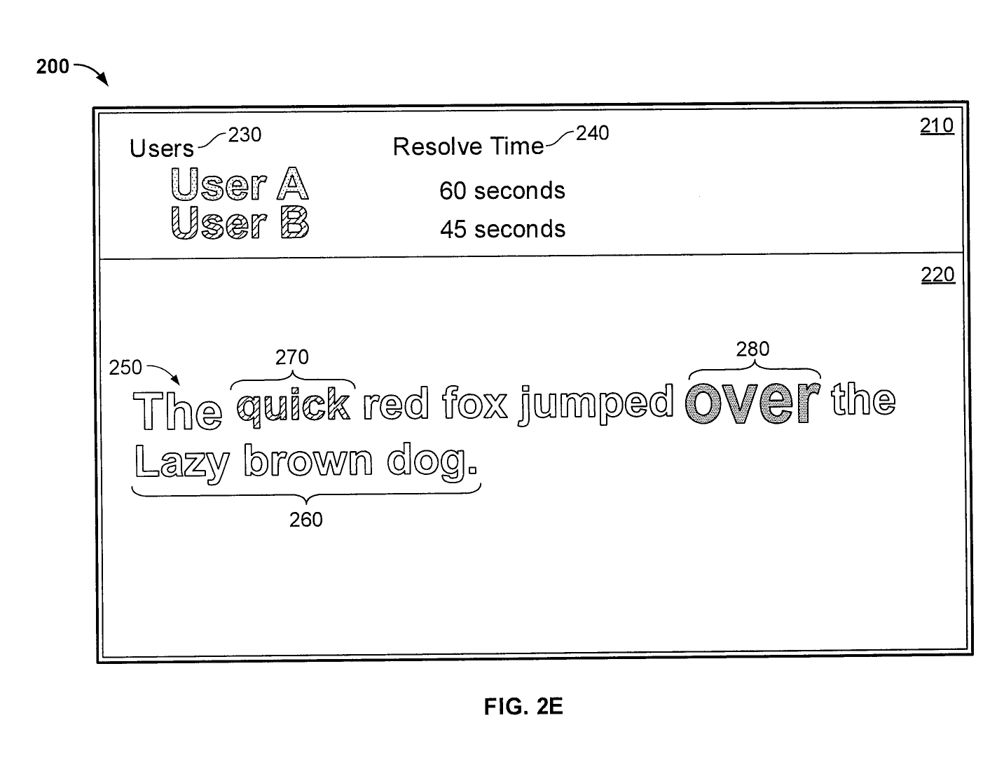

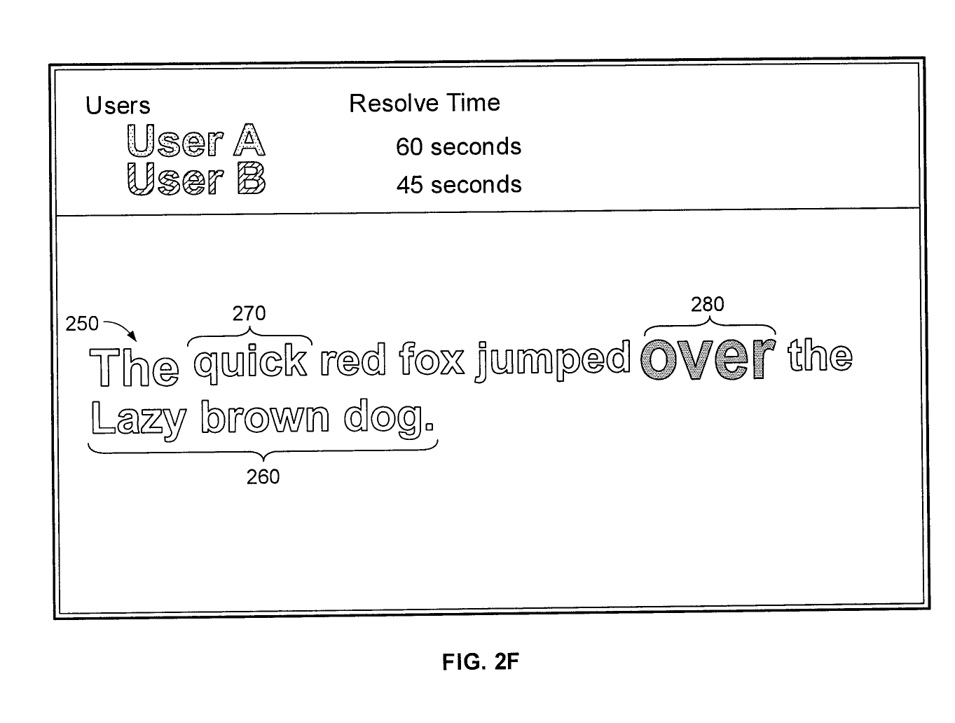

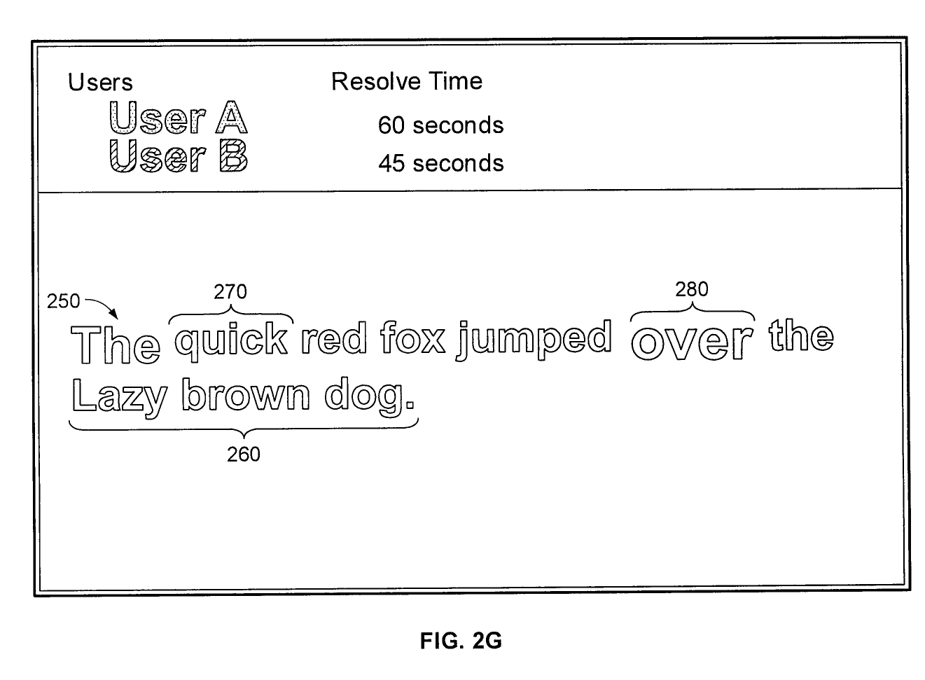

In accordance with one embodiment, FIGS. 2A through 2G illustrate an exemplary progression of the display 200 of a collaborative editing environment during an editing session of two users (e.g., User A and User B). Each of the participating users is editing the same document and any edit by one user is distributed to the other users participating in the collaborative editing session. In other words, each of FIGS. 2A through 2G represent a screen capture of at least a portion of the display of the collaborative environment reflecting the modifications made by User A and User B and transformation of the user modification from a user-associated style to a style of the underlying document. While the discussion below is directed to two users (e.g., User A and User B), a person of ordinary skill in the art would understand that participating in the collaborative editing environment is not limited to two users, and the features described herein can be adapted to three or more users.

FIG. 2A illustrates a display 200 of the collaborative editing environment prior to any user modifying the document being edited. The display 200 includes an information panel 210 and a document display panel 220. The document display panel 220 displays the contents of the text document being edited. The document text 250 of the text document contains the phrase, “The slow red fox jumped under the fence.” As no modifications have been made in FIG. 2A, the phrase is displayed in the style of the underlying document, which in this example is a black, Arial font.

The information panel 210 includes a user list 230, which displays the identity of the users participating in the collaborative editing session. As illustrated, the user list 230 identifies User A 231 and User B 232. The user list also indicates the style associated with each user by displaying the username in the font associated with the user. For example, User A 231 is displayed in an Arial Font having a white fill and black dots. User B is displayed in an Arial Font having a white fill with black diagonal lines. Thus, any modifications made by User A will be displayed in an Arial Font having a white fill and black dots, and any modifications made by User B will be displayed in an Arial Font having a white fill with black diagonal lines.

While illustrated herein using the text styling discussed above, a person of ordinary skill in the art would understand that other stylistic elements could be used to differentiate user-associated styles and the style of the underlying document. For example, styles can include differences in color, text size, and various effects, such as embossing, shadowing, underlining, and highlighting.

As discussed in more detail below, a modification by a user is initially displayed in a style associated with the user and gradually transitions to the style associated with the underlying document. A transition can be defined for each stylistic aspect of a style. For example, a transition can be defined to transform a first font (e.g., an Arial font into a Times New Roman font), a transition can be defined for transforming a first color into a second color (e.g., red into black), and a transition can be defined for transforming one effect to another (e.g., text shadowing into text embossing). The various transitions between stylistic aspects of a style can be combined to define a transformation from a user-associated style to the style of the underlying document.

The information panel 210 can further include the display of other user-configurable settings. For example, information panel 210 includes a list of user-configurable resolve time 240 for each user. The resolve time is the time that elapses between a user entering a modification, which is displayed in the user-associated style, and the display of the modification in the style of the underlying document. During the elapsed time, the display of the modification can gradually transform from the user-associated style to the document-style. The rate of transformation from the user-associated style to the document-style can be linear, exponential, logarithmic, or based on another function or progression.

The resolve time can be configured on a per-user basis. For example, display 200 indicates that User A 231 is associated with a 60 second resolve time 241 and User B 232 is associated with a 45 second resolve time 242. In other words, when User A modifies a document, that modification will initially appear in a style associated with User A. During the next 60 seconds, the display of the modification in document display panel 200 will gradually transform into the style of the underlying document. After 60 seconds has passed, the style of the modification will be the same as the style of the underlying document. Similarly, when User B modifies a document, that modification will initially appear in a style associated with User B. During the next 45 seconds, which the resolve time associated with User B, the display of the modification in document display panel 200 will gradually transform into the style of the underlying document. After 45 seconds has passed, the style of modification will be the same as the style of the underlying document.

Resolve time can be configured at a variety of levels. As noted above, each user can be associated with a resolve time. Alternatively, every user can be associated with the same resolve time. In a further alternative, the resolve time associated with a user can be configured across all computers participating in the collaborative editing session. Each user could set his/her own resolve time or one or more users could be authorized (e.g., administrator users) to set any user's associated resolve time.

The resolve time can also be configured on a per-display basis such that a user can control the resolve time associated with any other user participating in the collaborative editing session at the user's display without affecting the resolve time settings of any other user's display. For example, assuming display 200 is the display of the collaborative editing environment of User A, User A can configure the resolve time of User A as 60 seconds and User B as 45 seconds. However, the display of the collaborative editing environment of User B (not illustrated) could be configured to associate User A with a 30 second resolve time and User B with a 15 second resolve time.

The styles associated with each user can similarly be configured at a variety levels. For example, user-associated styles can be configured globally, on a per-display basis, or on a per-collaborative editing session basis.

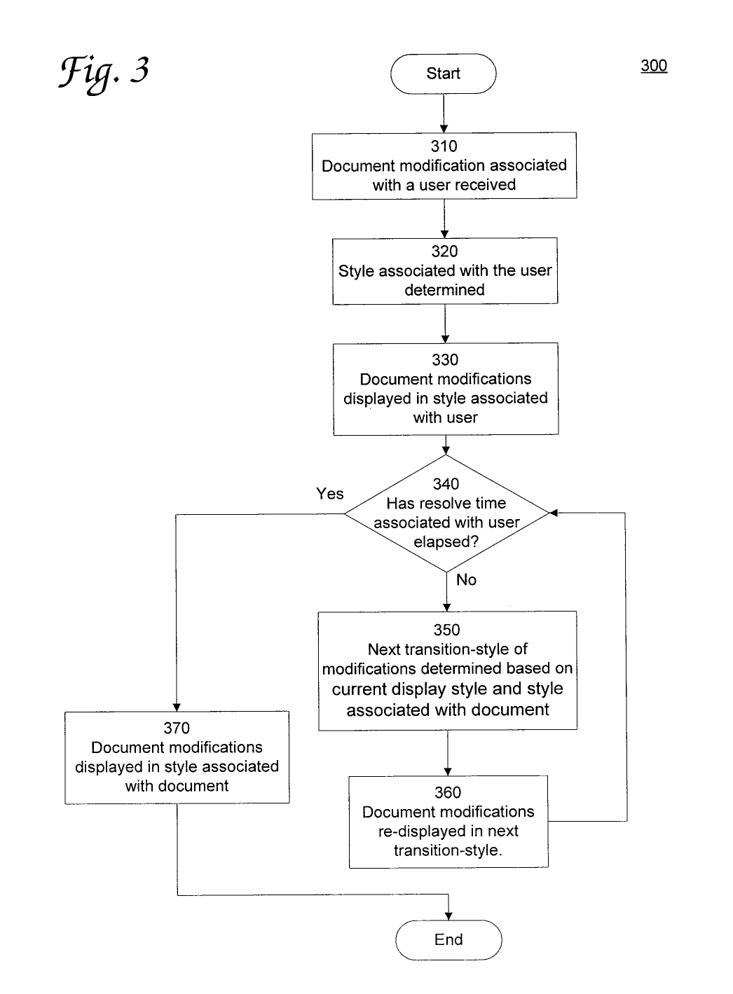

FIG. 2B illustrates display 200 after User A has made a first modification 260 to the document text 250 to delete the word “fence” and include the phrase “lazy brown dog.” Such that the document text 250 is the phrase, “The slow red fox jumped under the lazy brown dog.” According to the embodiment illustrated in FIGS. 2A-2G, deletions from a document are not illustrated by a transformation of styles, but are reflected in the display of the document as the deletion is made. Deletions from a document can be illustrated in a variety of ways as discussed in more detail below with respect to FIG. 3. According to the embodiment illustrated in FIGS. 2A-2G, additions to the document are displayed in the style of the user making the addition. Thus, the first modification 260 appears in the style associated with User A so that any user can quickly determine what modifications have been made and how recently they were made.

FIG. 2C illustrates display 200 after User B has entered a second modification 270. Specifically, in the second modification 270, User B has changed the word “slow” to “quick” such that the document text 250 is “The quick red fox jumped under the lazy brown dog.” The second modification 270 appears in the style associated with User B. However, because some time has passed since User A entered the first modification 260, the display of the first modification 260 (i.e., the phrase “lazy brown dog”) is in transition to a style that more closely resembles the style of the underlying document. Specifically, because the style associated with User A is a white fill with a pattern of black dots, the transition to a black, Arial font is gradually adding additional black dots. Thus, looking at the display 200, a user can quickly discern that User B recently made the second modification 270 (i.e., “quick”) and less recently, User A made the first modification 270 (i.e., “lazy brown dog”).

FIG. 2D illustrates the display 200 after User A has made a third modification 280 to the document text 250. The third modification 280 deletes changes the word “under” to the word “over” such that the document text 250 is “The quick red fox jumped over the lazy brown dog.” The third modification 280 is displayed in the style associated with User A. As time has elapsed since the second modification 270 was made, the display of the second modification 270 has begun to transform into the style of the underlying document (e.g., the diagonal stripes have become wider to increase the black-fill of the lettering. Similarly, the display of the first modification 260 has further transformed to the style of the underlying document and now appears as nearly black, except for scattered specs of white. It should be noted that while the first modification 260 and the third modification 280 were both made by User A, these modifications are at different stages of the transformation to the style of the underlying document and are therefore displayed differently.

FIG. 2E illustrates the display 200 at least 60 seconds after the first modification 260 was made. Thus, the first modification 260 is now displayed in the style of the underlying document. The second modification 270 and the third modification 280 have further transformed into the style of the underlying document.

FIG. 2F illustrates the display 200 at least 45 seconds after the second modification 270 was made. Thus, the second modification 270 is now displayed in the style of the underlying document. The third modification 280 has further transformed into the style of the underlying document.

FIG. 2G illustrates the display 200 at least 60 seconds after the third modification 280 was made. Thus, the third modification 280 is now displayed in the style of the underlying document. Thus, the document text 250, “The quick red fox jumped over the lazy brown dog.” is displayed entirely in the style of the underlying document.

An embodiment of a process 300 for providing the functionality described above is illustrated by a flow diagram in FIG. 3. The process 300 can be performed by one or more of the computers participating in the collaborative editing session, such as a server computer, client computer, peer computer, or one or more of the computers in a cloud-computing environment or any combination of one or more of them.

In accordance with process 300, at 310 a document modification associated with a user is received. In one example, document modifications are received at a computer as data entry via a keyboard, computer mouse, or other user input device. Alternatively, document modifications can be received as network data from another computer. The network data can encode information concerning data entry made via user-input device at a different computer participating in the collaborative editing session. The encoded information can include the changes to the document, the time the changes were made, the user that made the modification, a resolve time associated with the modification or the user, the style associated with the user, and other data.

Once the document modification is received, the style associated with the user is determined at step 320. In one embodiment, the user-associated style can be retrieved from the data received concerning the document modification. Alternatively, the user-associated style can be determined based on the identity of user associated with the document modification. For example, the identity of the user can be retrieved from the data received concerning the document modification, and the user-associated style can be determined based on a database lookup or run-time parameters of the collaborative editing environment. In accordance with yet a further feature, the user-associated style can also be determined, either at the client or at a server, according to a heuristic, such as the order in which collaborators (i.e., users) join the collaborative editing session.

At step 330, the modifications are displayed in the style associated with user. The display of the document modifications typically includes inserting the document modifications into the underlying document (i.e., applying the document modifications to the underlying document). The modifications to document are then rendered in the style associated with the user. Additions to the document (e.g., inserted text) are illustrated in the style associated with the user.

In one embodiment, deletions from the document are made without considering the user-associated style. For example, deleted text is simply removed from the display. In a further alternative, deletions are illustrated by fading the display of the deletion from the display of the document or shrinking the deleted element in size until no longer apparent.

After the document modifications have been displayed, at decision 340, it is determined whether the resolve time associated with the user has elapsed. In one embodiment, decision 340 can utilize a timer associated with each document modification. If the timer has expired, decision 340 determines the resolve time associated with the user has elapsed with respect to the associated document modification.

If it is determined at decision 340 that the resolve time has not expired, at step 350 the next transition-style of the document modification is determined. The next transition-style is determined based on a current display style of the document modification and the style of the underlying document. Each transition style is determined to give the appearance of a gradual transformation of the user-associated style to the document style. For example, if a document style includes black text, and a user-associated style displays document modification in red text, each transition style will darken the color of the document modification until the color of the text is black (i.e., the exemplary document style).

In other words, after a document modification is first entered, the current display is the user-associated style. The next transition-style is determined at step 350, and the document modification is re-displayed in the next transition style at step 360. Thus, the style of the document modification is iteratively determined and displayed as it transforms from the user-associated style to the style of the underlying document. It should be noted that each transition style can be pre-computed prior to use, based on the user-associated style and the style of the underlying document.

Transition functions can be implemented within the application to define the stylistic transformation from the user-associated style to the style of the underlying document. Such functions can be implemented by defining, for example, discrete color values and time intervals for altering a display from one discrete color to the next defined discrete color. Alternatively, standardized techniques can be utilized to implement the stylistic transformation. For example, the stylistic transformation can be defined by one or more transition properties provided in CSS3, which allows for the specification of which styles to transition, the time period over which to transition, and which transition function to use (e.g., linear, ease-in, etc.)

If it is determined at decision 340 that the resolve time has expired, at step 370, the document modification is displayed in the style of the underlying document. Thus, the document modification completes its transformation into the style of the underlying document and is not readily identifiable as a change to the document. In one embodiment, the transition styles determined at step 350 are chosen or computed (e.g., according to a transition function) such that when the resolve time has expired, the display of the document modification in the style of the underlying document will appear to complete the transformation from the user-associated style to the style of the underlying document.

When a first user modifies a specific portion of a document, the document modification associated with the first user is received, as described with respect to step 310. The document modification is then transformed from a user-associated style to the style of the underlying document, as described with respect to steps 320-370. If, during the execution of steps 320-370, a second document modification is received from a second user modifying the specific portion of the document undergoing transformation as described at steps 320-370, the second modification can be processed in a variety of ways.

In accordance with one alternative, the second modification can halt the transformation of the first modification and process 300 can restart at step 310 based on the received document modification associated with the second user. For example, if a first user is associated with the color red, and the second user is associated with the color blue, if the second user modifies a specific portion of the document that is mid-transformation from red to the style of the underlying document, the transformation will stop. The received document modification from the second user will be displayed and begin its transformation from blue to the style of the underlying document.

In a further alternative, the style associated with the first user and the style associated with the second user can be blended (e.g., additively combined). For example, with reference to the user style configuration described above, when the document modification associated with the second user is received, the modified portion of the document is displayed in purple (i.e., a blended style of red and blue). The portion of the document displayed in purple can then be transformed to the style of the underlying document, as described above.

In various embodiments, the method steps described herein, including the method steps described in FIG. 3, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 3. Certain steps of the methods described herein, including one or more of the steps of FIG. 3, may be performed by a server or by another processor in a network-based cloud-computing system. Certain steps of the methods described herein, including one or more of the steps of FIG. 3, may be performed by a client computer in a network-based cloud computing system. The steps of the methods described herein, including one or more of the steps of FIG. 3, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 3, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

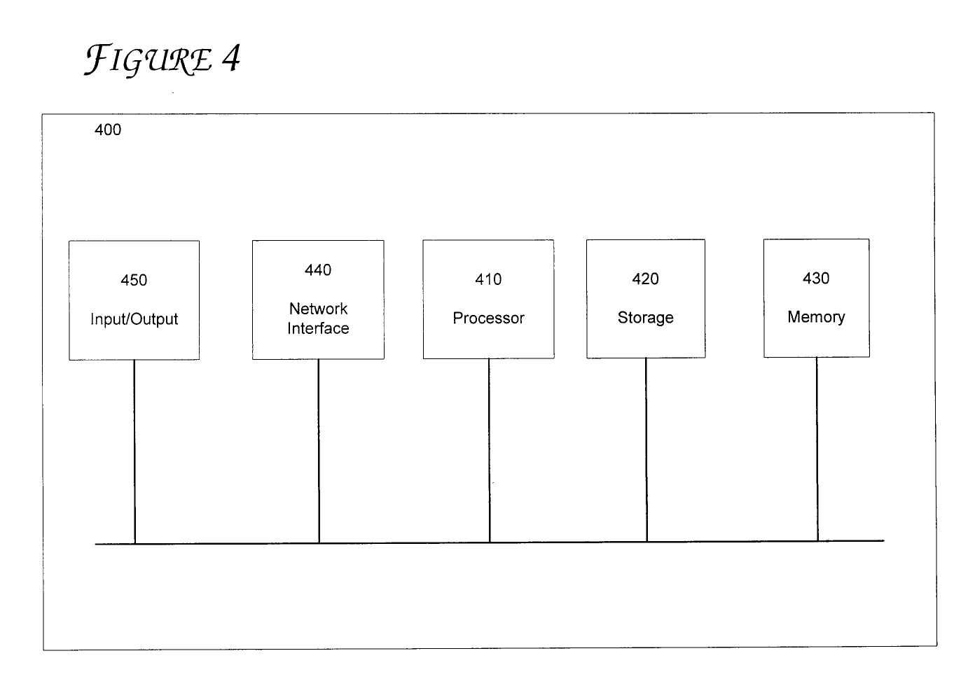

A high-level block diagram of an exemplary computer that may be used to implement systems, apparatus, and methods described herein is illustrated in FIG. 4. Computer 400 comprises a processor 410 operatively coupled to a data storage device 420 and a memory 430. Processor 410 controls the overall operation of computer 400 by executing computer program instructions that define such operations. The computer program instructions may be stored in data storage device 420, or other computer readable medium, and loaded into memory 430 when execution of the computer program instructions is desired. Thus, the method steps of FIG. 3 can be defined by the computer program instructions stored in memory 430 and/or data storage device 420 and controlled by processor 410 executing the computer program instructions. For example, the computer program instructions can be implemented as computer executable code programmed by one skilled in the art to perform an algorithm defined by the method steps of FIG. 3. Accordingly, by executing the computer program instructions, the processor 410 executes an algorithm defined by the method steps of FIG. 3. Computer 400 also includes one or more network interfaces 404 for communicating with other devices via a network. Computer 400 also includes one or more input/output devices 450 that enable user interaction with computer 400 (e.g., display, keyboard, mouse, speakers, buttons, etc.).

Processor 410 may include both general and special purpose microprocessors, and may be the sole processor or one of multiple processors of computer 400. Processor 410 may comprise one or more central processing units (CPUs), for example. Processor 410, data storage device 420, and/or memory 430 may include, be supplemented by, or incorporated in, one or more application-specific integrated circuits (ASICs) and/or one or more field programmable gate arrays (FPGAs).

Data storage device 420 and memory 430 each comprise a tangible non-transitory computer readable storage medium. Data storage device 420, and memory 430, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 450 may include peripherals, such as a printer, scanner, display screen, etc. For example, input/output devices 450 may include a display device such as a cathode ray tube (CRT) or liquid crystal display (LCD) monitor for displaying information to the user, a keyboard, and a pointing device such as a mouse or a trackball by which the user can provide input to computer 400.

Any or all of the systems and apparatus discussed herein, including computers 110A and 110B, tablet computers 120A, cellular telephone 120B, servers 170 and 180, database 185, cloud-computing environment 130, including servers 140, 150, 160 and database 165, and components thereof, may be implemented using a computer such as computer 400.

One skilled in the art will recognize that an implementation of an actual computer or computer system may have other structures and may contain other components as well, and that FIG. 4 is a high level representation of some of the components of such a computer for illustrative purposes.

The foregoing Detailed Description is to be understood as being in every respect illustrative and exemplary, but not restrictive, and the scope of the present disclsoure disclosed herein is not to be determined from the Detailed Description, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of the present disclosure. Those skilled in the art could implement various other feature combinations without departing from the scope and spirit of the present disclosure. The various functional modules that are shown are for illustrative purposes only, and may be combined, rearranged and/or otherwise modified.

1-20. (canceled)

21. A method for collaborative editing, comprising:
transmitting data adapted to cause a first device and a second device to display a first modification to a document by a first user in a first style associated with the first user, the document having a document style different than the first style, wherein the first device is associated with the first user and the second device is associated with a second user;
transmitting data adapted to transform a display, on the first device, of the first modification from the first style to the document style over a first period of time configurable by the first user; and
transmitting data adapted to transform a display, on the second device, of the first modification from the first style to the document style over a second period of time configurable by the second user, the first period of time comprising a configured amount of time different than the second period of time.

22. (canceled)

23. The method of claim 21, wherein transmitting data adapted to cause the first device and the second device to display the first modification is performed in response to the first user entering the first modification.

24. The method of claim 21, wherein the first period of time and the second period of time at least partially overlap.

25.-35. (canceled)

36. An article of manufacture including a non-transitory computer-readable medium having instructions stored thereon, that in response to execution by a computing device, causes the computing device to perform operations comprising:
transmitting data adapted to cause a first device and a second device to display a first modification to a document by a first user in a first style associated with the first user, the document having a document style different than the first style, wherein the first device is associated with the first user and the second device is associated with a second user;
transmitting data adapted to transform a display, on the first device, of the first modification from the first style to the document style over a first period of time configurable by the first user; and
transmitting data adapted to transform a display, on the second device, of the first modification from the first style to the document style over a second period of time configurable by the second user, the first period of time comprising a configured amount of time different than the second period of time.

37. The non-transitory computer readable medium of claim 36, wherein transmitting data adapted to cause the first device and the second device to display the first modification is performed in response to the first user entering the first modification.

38. The non-transitory computer readable medium of claim 36, wherein the first period of time and the second period of time at least partially overlap.

39. A system for collaborative editing, comprising a processor configured to:
transmit data adapted to cause a first device and a second device to display a first modification to a document by a first user in a first style associated with the first user, the document having a document style different than the first style, wherein the first device is associated with the first user and the second device is associated with a second user;
transmit data adapted to transform a display, on the first device, of the first modification from the first style to the document style over a first period of time configurable by the first user; and
transmit data adapted to transform a display, on the second device, of the first modification from the first style to the document style over a second period of time configurable by the second user, the first period of time comprising a configured amount of time different than the second period of time.

40. The system of claim 39, wherein the processor is configured to transmit data adapted to cause the first device and the second device to display the first modification in response to the first user entering the first modification.

41. The system of claim 39, wherein the first period of time and the second period of time at least partially overlap.
